(19) United States
(12) Patent Application Publication
(10) Pub. No.: US 2002/0124707 A1
(43) Pub. Date: Sep. 12, 2002

(54) Laser cut saw blades

(75) Inventor: Nowell William Izard, Masterton (NZ)

Correspondence Address: YOUNG & THOMPSON, 745 SOUTH 23RD STREET 2ND FLOOR, ARLINGTON, VA, 22202

(73) Assignee: IZARD INDUSTRIES LIMITED

(21) Appl. No.: 09/845,316

(22) Filed: May 1, 2001

(30) Foreign Application Priority Data
May 2, 2000 (NZ) 504287

(51) Int. Cl. B23D 61/00

(52) U.S. Cl. 83/835; 76/112; 76/25.1; 76/48

(57) ABSTRACT

A method of manufacturing a tungsten carbide tipped circular saw blade (S) The method and blade are characterised by pressing a rib pattern (R) into the body of the blade (S). The rib pattern strengthens the blade body and avoids warping, particularly in thin blades, e.g. less than 1 mm thick.

### BACKGROUND TO THE INVENTION

This invention relates to a circular saw blade, and an improved method for making the same.

The fabrication of a circular saw blade, particularly a tungsten carbide tipped blade, is a time consuming and expensive process.

The circular saw body is made from carbon steel and more recently stainless steel. One of the major problems that must be overcome is the tendency for the blade to be or become “out of flat” (warped) which can result in vibration and associated poor cutting during high-speed operation of the blade. This often occurs because of the stresses inherent in the metal blank or the various processes involved in manufacturing the blade that often includes the use/application of concentrated localised heat. The problem is often more acute in a blade that is thin (1 millimetre or less in thickness).

Clearly, it would be advantageous if a method could be found to produce a circular saw blade, particularly a thin tungsten carbide tipped blade, that is substantially flat and resistant to warping both subsequent to manufacture or in use.

### SUMMARY OF THE INVENTION

It is believed that the present invention provides for these objectives and preferably includes further advantages.

The invention provides a method of manufacturing a tungsten carbide tipped circular saw blade characterised by the steps:

(a) supplying a sheet steel strip or blank to a laser cutting machine;

(b) laser cutting an arbor and the periphery profile of the blade according to a predetermined computer controlled pattern;

(c) pressing a rib pattern into the blade;

(d) brazing the tungsten carbide saw tips at respective locations on the periphery of the blade; and

(e) grinding the final cutting profile to each of the tungsten carbide tips.

In a preferred method, the following step is performed prior to step (b):

(f) passing said sheet steel strip or blank through a leveller to take camber (coil set out) out of the strip.

The rib pattern of step (c) is preferably a multi-start spiral or radial or concentric ring pattern. The sheet steel strip or blank is preferably stainless steel, expediently pre-hardened 304 and 301 stainless in a thickness of 0.6 mm to 2.5 mm. Expediently, the blade bodies are of a diameter from 88 mm to 250 mm (3.5 inches to 10 inches). Optionally the laser may also cut heat expansion slots/patterns at the time of manufacture.

In the case where the material chosen for the blade is stainless steel, then an additional step is performed after step (d).

(g) electropolishing the blade to remove brazing residues and heat discolouration from the surfaces.

In a preferred method, the process of step (b) is performed with the aid of nitrogen gas to provide a clean non-carbonised cut.

The invention also provides a tungsten carbide tipped circular saw blade when made in accordance with the method described above.

### BRIEF DESCRIPTION OF THE DRAWINGS

FIG. 1 is an elevational view of a circular saw body according to the invention;

FIG. 2 is a sectional view taken along line A-A.

### DESCRIPTION OF THE PREFERRED EMBODIMENT

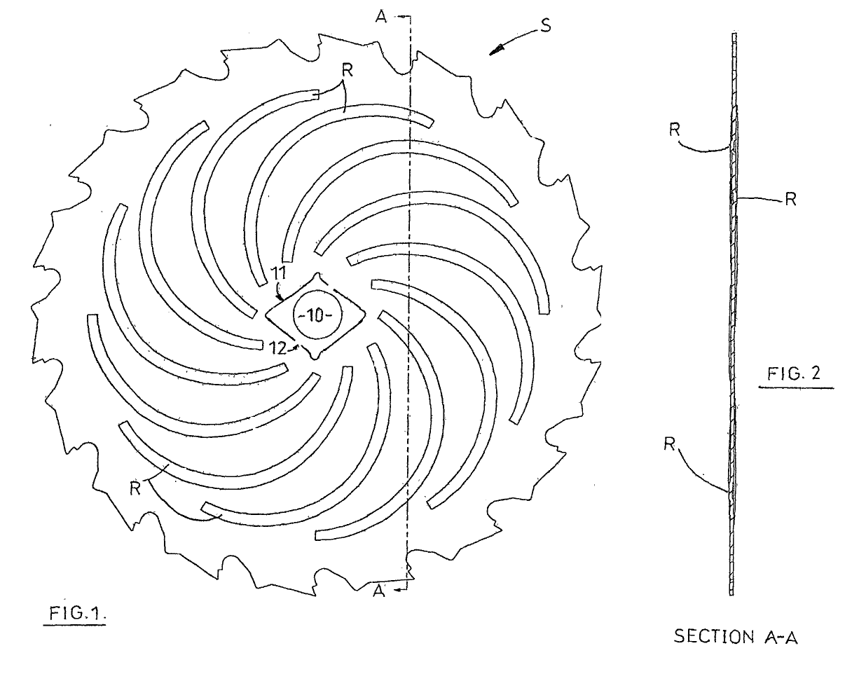

Referring to FIGS. 1 and 2, the blade is provided with a plurality of ribs R pressed into the body to add additional wall strength and to flatten the blank saw body. The strengthening rib pattern is preferably a multi-start spiral or radial or concentric ring pattern in an alternating pattern, that is, one rib protrudes from the surface on one side whilst the adjacent rib protrudes from the surface on the other side (see FIG. 2). It is believed that the ribs also enhance the appearance of the finished saw blade.

Furthermore ribs R, when in the form of a multi-start spiral as illustrated perform an impeller function and direct airflow to the peripheral edge when blade S is spinning in use. This air flow cools the cutting area.

### EXAMPLE

The first step of manufacture involves selection of the base material, in this example coils of 300 or 400 series stainless steel which weigh, 5-10 tons and have a gauge of 0.6 mm to 2.5 mm depending the end product required. The coils measure approx. 1216 mm wide and are pre-hardened to a suitable Rockwell hardness for saw blades, typically 36-44 RC. The coils are then split down to size, stress relieved, flattened and cut into squares to approximately the size of the saw blade to be produced. This is done using multi-directional levelling rollers.

The square blanks are then checked for flatness before laser cutting takes place.

In the next step the arbor and blade periphery are cut from the stainless steel blanks using a high powered CO₂ laser using pure nitrogen as an assist gas, to give a clean non-carbonised cut. This means that there is no need to clean the saw tip pockets with a sand blaster or grinding wheel which would otherwise be necessary for the next step of brazing the carbide tips in place.

In the next step, the blades are ribbed in a press tool to add additional wall strength and to flatten the blank saw body. It is found that forming the grooves in a multi-start spiral or radial manner gives maximum cross-sectional support and provides the effect of flattening and stress relieving the blank. This step is particularly relevant as it short cuts normal manufacturing methods. Traditionally saw blades are stress relieved using expensive heat treatments to achieve flatness. The substitution of this step provides major cost savings in the manufacture of these saw blades. Additionally, it has been found that thinner wall thickness material can now be used as the ribbed bodies have additional wall strength. This reduces the cost as less material is used.

The next step is brazing the tungsten carbide saw tips onto the periphery of the saw body which is done by using proprietary automatic brazing machines suitable for saw blade production. The heat source for brazing in this case is a gas flame, but induction, TIG or even lasers can be used for this purpose. Brazing is completed using a silver based filler metal and a brazing flux to make the brazed bond good and strong.

The next step comprises the electropolishing process. This is performed at this stage to clean up the brazing marks left behind after the brazing process, and to polish the saw body to a suitable shiny finish. This process is unique to stainless steel, thus avoiding the processes associated with carbon steel that require sand blasting the brazed area and polishing or finishing mechanically, to make the saw body presentable. The carbon steel saw then requires the application of a rust preventative coating to stop corrosion. Stainless steel saws do not require these processes. The electropolishing is done by immersing the saw blades into various tanks wherein the primary tank contains an electrolyte fluid (Electropol SS 92). An electric current is passed through from the saw blades to the walls of the electro-tank, thus removing the brazing soot and heat marks and polishing the saws at the same time. The power source is a 300 amp low voltage rectifier.

In the next step, the tungsten carbide tips of the cleaned and polished brazed blades are ground using an automatic diamond wheel grinding machine. The reason the carbide saw tips are sharpened after electropolishing is that the electropolishing dulls the carbide, eating at the binding material in the matrix of the carbide tip. Grinding after polishing produces a shiny sharp saw tip.

The final step is inspection and packaging of the finished product.

It will be appreciated that the above description is by way of example only and alternative process steps are envisaged within the scope of the invention.

Referring to FIG. 1 of the drawings, there is shown a saw blade S having a conventional 16 mm arbor 10 and a knock out diamond shaped arbor 11. The body is shown without Carbide teeth being brazed thereto. These are not of importance to this invention.

The diamond arbor portion 11 is retained on to the body portion by means of one, two, three, four or more tags 12. The cutting laser cuts the diamond arbor and the tags 12 to ensure they are large enough to provide sufficient strength for the blade to function when used with the circular arbor 10. In any event, most saws use a locking flange F (not shown), which would substantially cover the portion of the blade beyond the diamond shaped or enlarged arbor 12 so that strength of the tags is not necessarily a critical factor.

The saw body is made from steel or stainless steel sheet, preferably pre-hardened 304 or 301 stainless. The advantages of this material is that it is naturally rust resistant, and with the use of electropolishing (reverse electroplating) gives a near mirror, low friction and aesthetically appealing finish. It is surprising and unexpected that the electropolishing process removes the residue brazing fluxes, other residues and associated heat discolourations and marks.

We claim:

1. A method of manufacturing a tungsten carbide tipped circular saw blade characterised by the steps of
a) supplying a sheet steel strip or blank to a laser cutting machine;
b) laser cutting an arbor and the periphery profile of a blade according to a predetermined computer controlled pattern;
c) pressing a rib pattern into the blade;
d) brazing tungsten carbide saw tips at respective locations on the periphery of the blade; and
e) grinding the final cutting profile to each of the tungsten carbide tips.

2. The method of claim 1 wherein prior to performing step (b), the sheet or blank is passed through a leveller to take camber (coil set out) out of the strip.

3. The method of claim 1 wherein the rib pattern of step (c) is a multi-spiral pattern.

4. The method of claim 1 wherein the rib pattern of step (c) is a radial pattern.

5. The method of claim 1 wherein the rib pattern of step (c) is a concentric ring pattern.

6. The method of claim 1 wherein the sheet or blank is stainless steel.

7. The method of claim 6 wherein the sheet or blank is pre-hardened 304 and 301 stainless steel in a thickness of 0.6 mm to 250 mm in diameter.

8. The method of claim 1 wherein the circular blade is from 88 mm to 250 mm in diameter.

9. The method of claim 6 wherein, prior to performing step (e), the blade is electropolished for removal of brazing residues and heat discolouration.

10. The method of claim 1 wherein the laser cutting machine cuts heat expansion slots/patterns into the saw blade.

11. The method of claim 1 wherein step (b) is performed with the aid of nitrogen gas.

12. The method of claim 1 wherein the arbor is diamond shaped.

13. The method of any claim 1 wherein the rib pressing results in an alternating pattern between one surface of the blade and the other, e.g. one rib protrudes from the surface on one side whilst an adjacent rib protrudes from the surface on the other side.

14. A tungsten carbide tipped circular saw blade including a pattern of ribs extending from one or each side of said saw blade.

15. The saw blade of claim 14, made from stainless steel.

16. The saw blade of claim 14 or 15 wherein the blade thickness is 0.6 mm to 2.5 mm and with a diameter of 88 mm to 250 mm.

17. The saw blade of claim 14 wherein the pattern is a multi-start spiral.
